(19) United States
(12) Patent Application Publication
(10) Pub. No.: US 2012/0182496 A1
(43) Pub. Date: Jul. 19, 2012

(54) LIGHTING DEVICE, DISPLAY DEVICE, AND TELEVISION RECEIVER

(75) Inventor: Shinnosuke Nozawa, Osaka-shi (JP)

(73) Assignee: SHARP KABUSHIKI KAISHA, Osaka-shi, Osaka (JP)

(21) Appl. No.: 13/496,929

(22) PCT Filed: Sep. 1, 2010
(86) PCT No.: PCT/JP10/64885

§ 371 Date: Mar. 19, 2012

(30) Foreign Application Priority Data
Oct. 5, 2009 (JP) 2009-231746

(51) Int. Cl. G02F 1/1335; G09F 13/04

(52) U.S. Cl. 349/61; 362/97.1

(57) ABSTRACT

An object of the present invention is to achieve reduction in power consumption and to obtain sufficient heat dissipation performance in a lighting device. A backlight unit 12 of the lighting device includes LEDs 17 serving as a plurality of light sources; a chassis 14 housing the LEDs 17; cooling fans 22 serving as a plurality of cooling portions arranged at positions corresponding to locations of the LEDs 17 in the chassis 14; a light source control portion controlling driving of the LEDs 17; and an LED control portion 33 serving as a cooling control portion controlling driving of the corresponding cooling fans 22 based on driving of the LEDs 17.

### TECHNICAL FIELD

The present invention relates to a lighting device, a display device, and a television receiver.

### BACKGROUND ART

A liquid crystal panel included in a liquid crystal display device, such as a liquid crystal television set, does not emit light, and thus a backlight unit is required as an external lighting device that supplies illumination light to the liquid crystal panel. This backlight unit is required to reduce the power consumption and improve the brightness along with the recent increase in size of liquid crystal display devices. To satisfy such a demand, the backlight unit using LEDs as light sources is drawing attention.

Incidentally, when LEDs are used for a long period of time under high-temperature environments, the brightness and the product lifetime may considerably deteriorate. In this regard, a cooling structure for cooling LEDs is proposed. Examples of the structure are disclosed in Patent Documents 1 and 2 mentioned below.

Patent Document 1: Japanese Unexamined Patent Publication No. 2008-34342

Patent Document 2: Japanese Unexamined Patent Publication No. 2005-340065

Problem to be Solved by the Invention

In the cooling structure provided in the backlight unit disclosed in Patent Documents 1 and 2 described above, a cooling fan is used. The cooling fan is driven to cool LEDs. However, the backlight unit described above has a so-called entire cooling structure in which the entire cooling is achieved by circulating the air within the backlight unit by convection using the cooling fan. As a result, the power consumption necessary for driving the cooling fan tends to increase and uneven cooling is likely to occur. Furthermore, a large cooling fan is required, which may lead to a problem of an increase in size of the entire cooling structure, for example.

### DISCLOSURE OF THE PRESENT INVENTION

The present invention was made in view of the foregoing circumstances, and therefore has an object to achieve low power consumption and obtain a sufficient radiation performance.

Means for Solving the Problem

A lighting device according to the present invention includes a plurality of light sources, a chassis housing the light sources, a plurality of cooling portions arranged on the chassis at positions corresponding to locations of the light sources, a light source control portion configured to control driving of the light sources, and a cooling control portion configured to control driving of one of the cooling portions based on driving of a corresponding light source.

With this configuration, the light source control portion is configured to control driving of the plurality of light sources, and the cooling control portion is configured to control driving of one of the cooling portions based on driving of a corresponding light source. At this time, for example, control can be performed such that the cooling portions corresponding to lit light source are driven and the cooling portions corresponding to unlit light source are not driven. Thus, the plurality of cooling portions are arranged at positions corresponding to locations of the light sources and the cooling portions are selectively driven, thereby enabling selective cooling of the light sources in which heat is generated upon lighting. Accordingly, in comparison with a configuration in which the entire lighting device is cooled, the light sources that need to be cooled can be effectively cooled while reducing the power consumption involved in driving the cooling portions. Further, uneven cooling hardly occurs and the cooling portions can remain small.

### BRIEF DESCRIPTION OF THE DRAWINGS

FIG. 1 is an exploded perspective view showing a schematic configuration of a television receiver according to one embodiment of the present invention;

FIG. 2 is an exploded perspective view showing a schematic configuration of a liquid crystal display device included in the television receiver;

FIG. 3 is a sectional view showing a sectional configuration taken along the long-side direction of the liquid crystal display device;

FIG. 4 is an enlarged sectional view showing a sectional configuration taken along the short-side direction of the liquid crystal display device;

FIG. 5 is a plan view showing an arrangement configuration of an LED board and a holding member in a chassis included in the liquid crystal display device;

FIG. 6 is a bottom view showing an arrangement configuration of cooling fans in the chassis included in the liquid crystal display device;

FIG. 7 is an enlarged view of FIG. 5;

FIG. 8 is an enlarged view of FIG. 6;

FIG. 9 is a block diagram schematically showing an electrical configuration in the television receiver; and

FIG. 10 is a block diagram schematically showing an electrical configuration associated with driving of LEDs and cooling fans.

### BEST MODE FOR CARRYING OUT THE INVENTION

### One Embodiment

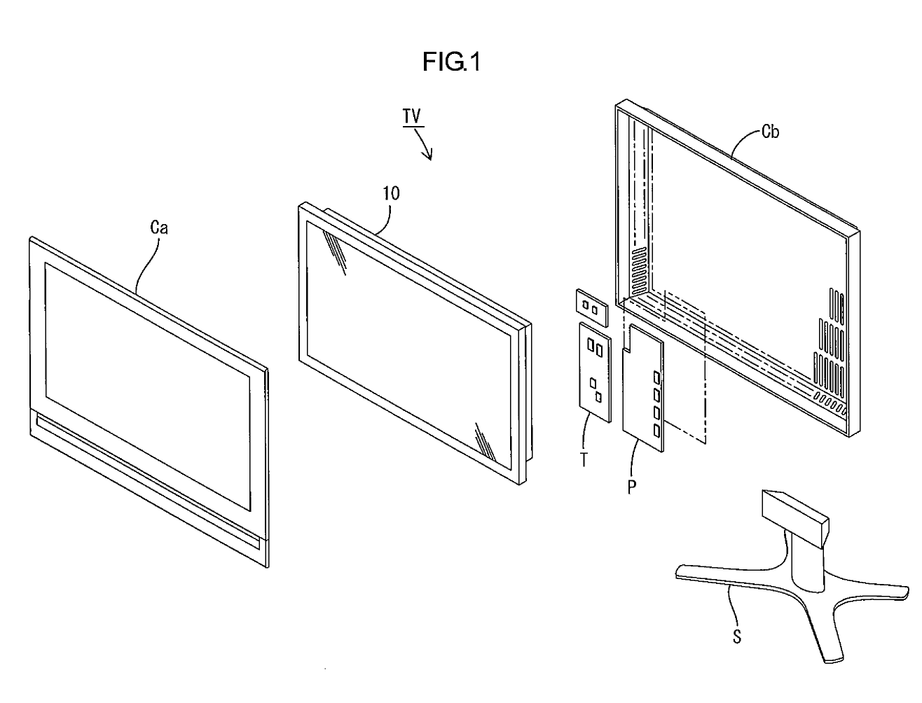

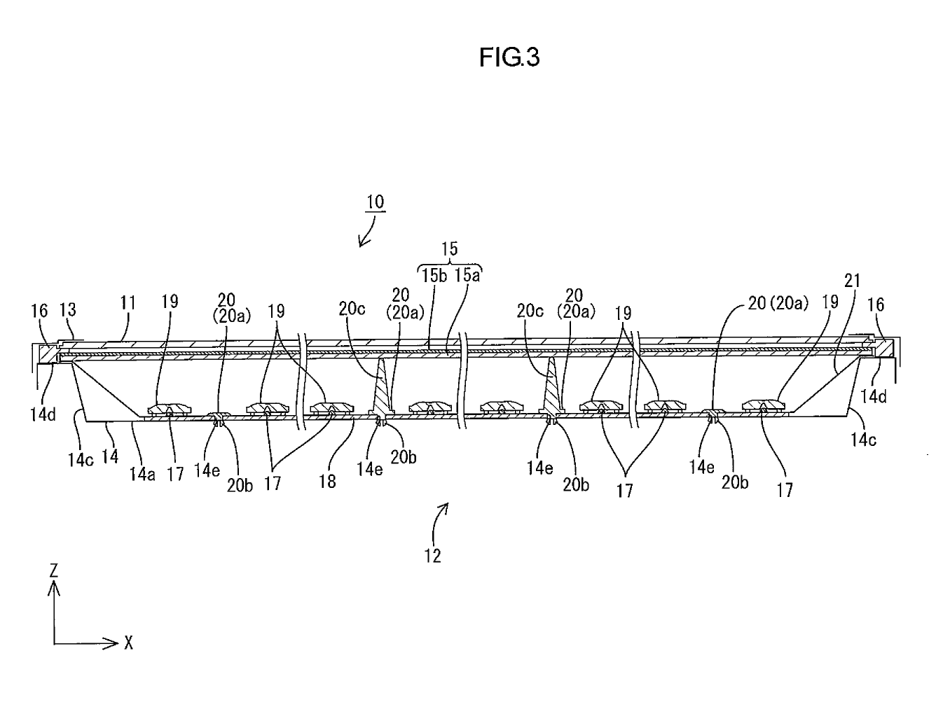

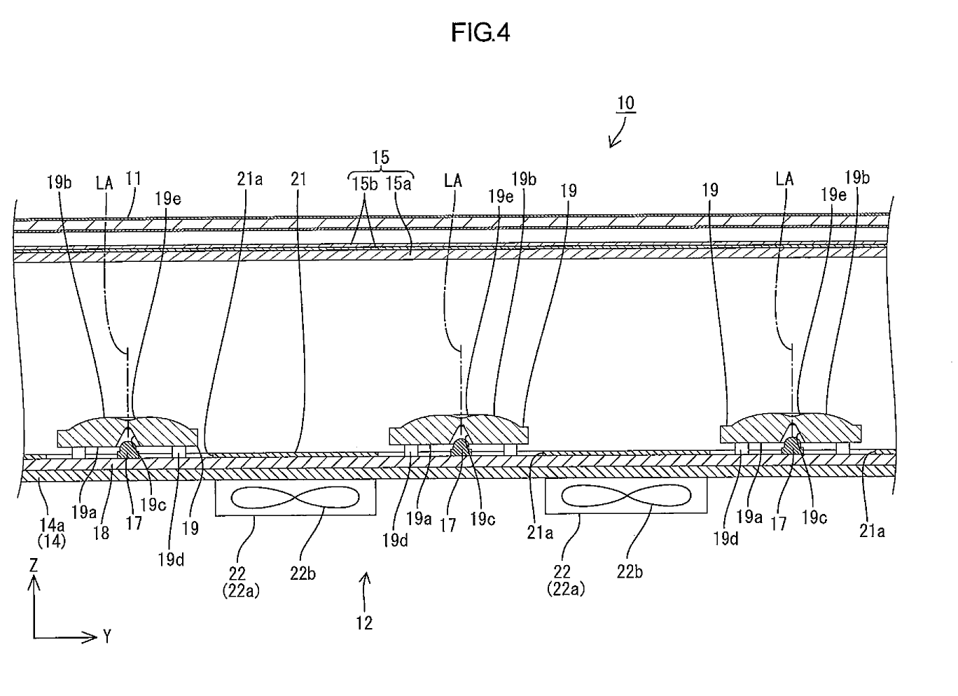

One embodiment of the present invention will be described with reference to FIGS. 1 to 10. In this embodiment, a liquid crystal display device 10 is illustrated. An X-axis, a Y-axis, and a Z-axis are illustrated in a part of each of the figures, and illustration is made such that the axial directions respectively correspond to the directions illustrated in each figure. The upper side shown in FIGS. 3 and 4 is defined as the front side and the lower side shown in FIGS. 3 and 4 is defined as the back side.

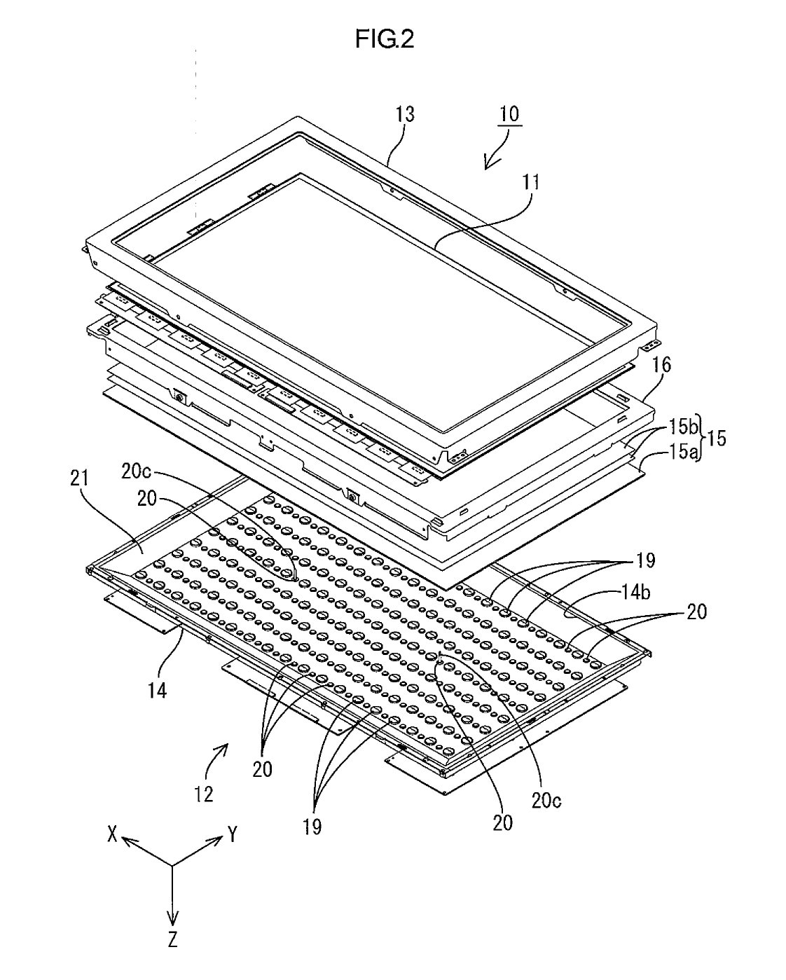

As shown in FIG. 1, a television receiver TV according to this embodiment includes the liquid crystal display device 10, front and back cabinets Ca and Cb sandwiching and housing the liquid crystal display device 10; a power source P; a tuner T; and a stand S. The liquid crystal display device (display device) 10 has a horizontally long square shape (rectangular shape) as a whole, and is housed in a vertically placed state. As shown in FIG. 2, the liquid crystal display device 10 includes a liquid crystal panel 11 serving as a display panel, and a backlight unit (lighting device) 12 serving as an external light source. These are integrally held by a frame-like bezel 13 or the like.

Next, the liquid crystal panel 11 and the backlight unit 12, each of which constitutes the liquid crystal display device 10, will be sequentially described. The liquid crystal panel (display panel) 11 has a rectangular shape in plan view, and has a configuration in which a pair of glass substrates is bonded together with a predetermined gap and a liquid crystal is encapsulated in the gap between the both glass substrates. One of the glass substrates is provided with switching components (for example, TFTs) connected to source lines and gate lines which are orthogonal to each other; pixel electrodes connected to the switching components; and an alignment film, for example. The other glass substrates is provided with color filters including color sections for R (red), G (green), B (blue), and the like arranged in a predetermined array; counter electrodes, and an alignment film, for example. Note that a polarizing plate is arranged on the outside of each of the substrates.

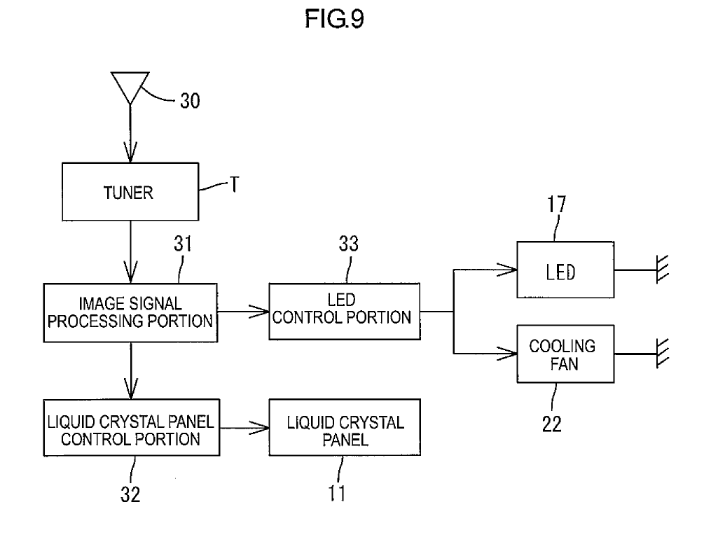

As shown in FIG. 9, driving of the liquid crystal panel 11 having the configuration described above is controlled by a liquid crystal panel control portion 32. This liquid crystal panel control portion 32 is configured to output control signal to the liquid crystal panel 11 based on output signal output from an image signal processing portion 31. Light is supplied from the backlight unit 12 in cooperation with the control by the liquid crystal panel control portion 32, thereby enabling display of a desired image on the display screen of the liquid crystal panel 11. The image signal processing portion 31 is configured to receive image signal such as television broadcasting signal input to the tuner T via an antenna 30. The image signal processing portion 31 is configured to perform image processing on the received signal and to output the processed signal to the liquid crystal panel control portion 32 and the like.

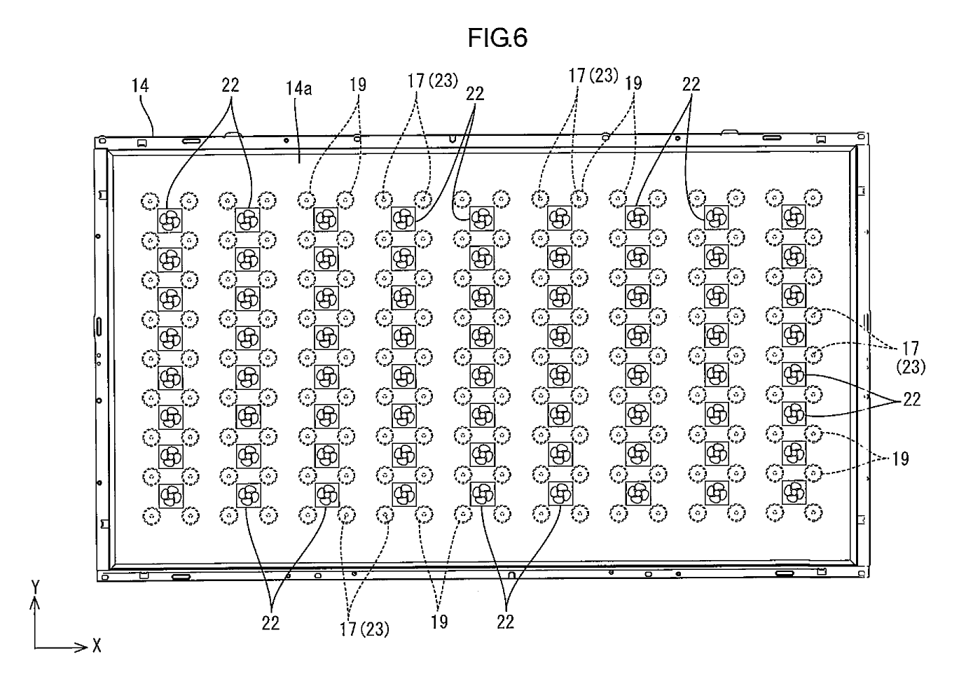

The backlight unit 12 will be described in detail. As shown in FIGS. 2 and 3, the backlight unit 12 includes a chassis 14 having a substantially box shape with an opening 14b formed on a light output surface side (side of the liquid crystal panel 11); a group of optical members 15 (a diffuser plate (light diffusing member) 15a and a plurality of optical sheets 15b arranged between the diffuser plate 15a and the liquid crystal panel 11) arranged to cover the opening 14b of the chassis 14; and a frame 16 arranged along an outer edge portion of the chassis 14 and holding an outer edge portion of the group of optical members 15 by sandwiching with the chassis 14. Additionally, the chassis 14 includes LEDs (Light Emitting Diodes) 17 serving as light sources; an LED board 18 on which the LEDs 17 are mounted; and diffuser lenses 19 attached to the positions corresponding to the LEDs 17 on the LED board 18. Moreover, the chassis 14 includes holding members 20 configured to hold the LED board 18 with the chassis 14, and a reflection sheet 21 reflecting light within the chassis 14 toward the side of the optical members 15. Outside the chassis 14, cooling fans 22 are installed to achieve cooling of the LEDs 17 through the chassis 14 (FIGS. 4 and 6). Note that in the backlight unit 12, the side closer to the optical members 15 than the LEDs 17 is referred to as a light output side. Hereinafter, each component of the backlight unit 12 will be described in detail.

The chassis 14 is made of metal, and includes, as shown in FIGS. 2 and 3, a bottom plate 14a having a rectangular shape like the liquid crystal panel 11; side plates 14c rising from outer edges of each side of the bottom plate 14a; and support plates 14d projecting outward from the rising ends of the side plates 14c. The chassis 14 has a shallow, substantially box shape (substantially shallow pan shape) opened toward the front side, as a whole. The long-side direction of the chassis 14 is aligned with the X-axis direction (horizontal direction), and the short-side direction thereof is aligned with the Y-axis direction (vertical direction). The frame 16 and the optical members 15 described later can be placed from the front side on each support plate 14d in the chassis 14. The frame 16 is screwed into each support plate 14d. The bottom plate 14a of the chassis 14 has attaching holes 14e opened to attach the holding members 20. The plurality of attaching holes 14e are arranged in a dispersed manner to correspond to the attaching positions of the holding members 20 on the bottom plate 14a.

As shown in FIG. 2, the optical members 15 each have a horizontally long square shape (rectangular shape) in plan view, like the liquid crystal panel 11 and the chassis 14. As shown in FIG. 3, the outer edge portions of the optical members 15 are placed on the support plates 14d to thereby cover the opening 14b of the chassis 14, and the optical members 15 are interposed between the liquid crystal panel 11 and the LEDs 17. The optical members 15 include the diffuser plate 15a arranged on the back side (on the side of the LEDs 17, the side opposite to the light output side), and the optical sheets 15b arranged on the front side (on the side of the liquid crystal panel 11, the light output side). The diffuser plate 15a has a configuration in which a number of diffusing particles are dispersed within a base substrate made of a substantially transparent resin having a predetermined thickness, and has a function of diffusing transmitted light. The optical sheets 15b each have a sheet shape with a smaller thickness than that of the diffuser plate 15a and are formed by two sheets stacked thereon (FIG. 2). Specific examples of the types of the optical sheets 15b include a diffuser sheet, a lens sheet, and a reflection type polarizing sheet. The optical sheets may be appropriately selected from among these examples to be used.

As shown in FIG. 2, the frame 16 has a frame shape formed along the outer peripheral edge portions of the liquid crystal panel 11 and the optical members 15. The outer edge portion of the optical member 15 can be sandwiched between the frame 16 and each support plate 14d (FIG. 3). Further, the frame 16 is configured to receive the outer edge portion of the liquid crystal panel 11 from the back side and to sandwich the outer edge portion of the liquid crystal panel 11 with the bezel 13 arranged on the front side.

Next, the LEDs 17 and the LED board 18 on which the LEDs 17 are mounted will be described. As shown in FIGS. 3 and 4, the LEDs 17 are configured such that an LED chip is encapsulated with a resin material on a board portion fixed to the LED board 18. The LED chip mounted on the board portion has a one type of main emission wavelength. Specifically, an LED chip emits a single color light of blue. In the resin material for encapsulating the LED chip, a phosphor for converting blue light emitted from the LED chip into white light is dispersed and blended. This enables the LEDs 17 to emit white light. The LEDs 17 are so-called top-type LEDs whose side opposite to the mounting surface with respect to the LED board 18 serves as a light emitting surface.

As shown in FIGS. 3 and 4, the LED board 18 has a rectangular plate shape in plan view that covers substantially the entire area of the bottom plate 14a of the chassis 14. The LED board 18 extends along the bottom plate 14a and is housed in the chassis 14 in the state where the long-side direction thereof aligned with the X-axis direction and the short-side direction thereof aligned with the Y-axis direction. The base member of the LED board 18 is made of metal such as an aluminum-based material like the chassis 14, and has a wiring pattern formed of a metal film, such as copper foil, on the surface through an insulating layer. Note that an insulating material such as ceramic can also be used as the material for the base member of the LED board 18. The LEDs 17 having the configuration described above are mounted on the plate surface of the LED board 18 which faces the front side (surface facing the side of the optical members 15). A number of LEDs 17 are arranged in a matrix in the row direction corresponding to the X-axis direction (the long-side direction of each of the chassis 14 and the LED board 18) and in the column direction corresponding to the Y-axis direction (the short-side direction of each of the chassis 14 and the LED board 18) on the LED board 18, and are connected to wiring patterns, which are not shown, formed on the LED board 18. Specifically, 18 LEDs 17 are arranged in rows in the X-axis direction and nine LEDs 17 are arranged in columns in the Y-axis direction on the LED board 18. The array pitch of the LEDs 17 is substantially constant, that is, it can be said that the LEDs 17 are arrayed at regular intervals.

The wiring patterns routed and formed on the LED board 18 are connected with a LED control portion 33 as shown in FIG. 9. This LED control portion 33 is configured to control driving of each LED 17 based on signal received from the image signal processing portion 31. Accordingly, the LED control portion 33 is configured to appropriately control whether to light each LED 17 depending on an image to be displayed on the liquid crystal panel 11. Specifically, when the image to be displayed on the liquid crystal panel 11 includes a black display area and a non-black display area, the LEDs 17 arranged to supply light mainly to the non-black display area are lit, while the LEDs 17 arranged to supply light mainly to the black display area are unlit. This makes it possible to ensure a large difference in brightness between the black display area and the non-black display area, thereby obtaining a high contrast performance. Note that in FIG. 9, only one LED 17 is illustrated for convenience.

The diffuser lenses 19 are substantially transparent (having high light transmissive ability) and are formed of a synthetic resin material (for example, polycarbonate or acrylic) having a refractive index higher than that of the air. As shown in FIGS. 3 to 5, the diffuser lenses 19 have a predetermined thickness and a substantially circular shape in plan view, and are attached to the LED board 18 so as to cover each of the LEDs 17 from the front side, that is, to overlap with the LEDs 17. The diffuser lenses 19 are configured to diffuse light emitted from each LED 17 and light having a strong directivity is exited therefrom. That is, the directivity of the light emitted from each LED 17 is reduced through the diffuser lenses 19. As a result, if the adjacent LEDs 17 are arranged at larger intervals, each area formed therebetween is hardly recognized as dark portions. This enables reduction in the number of the LEDs 17 to be installed. Each diffuser lens 19 is arranged at the position substantially concentric to each LED 17 in plan view.

The surface of each diffuser lens 19, which faces the back side and is opposed to the LED board 18, is defined as a light incidence surface 19a into which the light from each LED 17 enters. The surface of each diffuser lens 19, which faces the front side and is opposed to the optical member 15, is defined as a light output surface 19b from which the light is output. Of these surfaces, the light incidence surface 19a is formed in parallel along the plate surface of the LED board 18 (X-axis direction and Y-axis direction) as a whole, as shown in FIG. 4. Meanwhile, a light-incidence-side recess 19c is formed in an area overlapping with each LED 17 in plan view, thereby providing an inclined surface inclined with respect to an optical axis LA of each LED 17. The light-incidence-side recess 19c has a substantial conical shape with an inverted V-shaped cross-section and is formed at substantially a concentric position with each diffuser lens 19. Light emitted from each LED 17 and entering the light-incidence-side recess 19c enters the diffuser lens 19 while being refracted at a wide angle by the inclined surface. An attaching leg portion 19d serving as an attaching structure for the LED board 18 projects from the light incidence surface 19a. The light output surface 19b is formed in a flat and substantially spherical surface shape, which enables output of the light exited from the diffuser lenses 19 while refracting the light at a wide angle. In an area overlapping with each LED 17 in plan view on the light output surface 19b, a light-output-side recess 19e having a substantial bowl shape is formed. This light-output-side recess 19e enables output of the light from each LED 17 while refracting the light at a wide angle, or reflection of part of the light from each LED 17 to the side of the LED board 18.

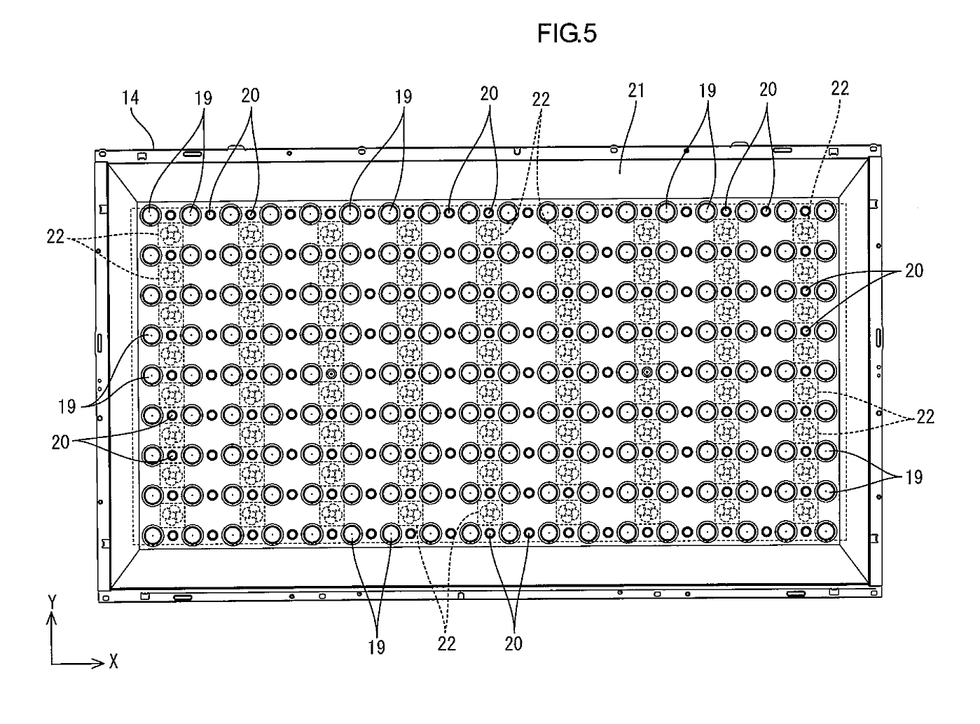

Subsequently, the holding member 20 will be described. The holding members 20 are made of a synthetic resin such as polycarbonate, and the surface thereof has a white color that exhibits excellent light reflectivity. As shown in FIG. 3, the holding members 20 each include a body portion 20a formed along the plate surface of the LED board 18, and a fixed portion 20b projecting toward the backs side, that is, toward the side of the chassis 14, from the body portion 20a and fixed to the chassis 14. The body portion 20a has a substantially circular plate shape in plan view, and is configured to sandwich the LED board 18 and the reflection sheet 21 with the bottom plate 14a of the chassis 14. The fixed portion 20b penetrates through the corresponding attaching hole 14e formed to correspond to the attaching position of each holding member 20 in the bottom plate 14a of the chassis 14 and is configured to be engaged with respect to the bottom plate 14a. As shown in FIG. 5, a number of holding members 20 are arranged in parallel with each other in a matrix within the plane of the LED board 18. Specifically, the holding members 20 are arranged at positions between the diffuser lenses 19 (LEDs 17) adjacent to each other in the X-axis direction.

As shown in FIGS. 2 and 3, a pair of the holding members 20 arranged at the center side of the screen, among the holding members 20, is provided with a support portion 20c projecting from the body portion 20a to the front side. This support portion 20c is configured to support the diffuser plate 15a from the back side, thereby making it possible to maintain the positional relationship in the Z-axis direction between the LEDs 17 and the optical members 15 constant and regulating unintentional deformation of the optical members 15.

The reflection sheet 21 is made of a synthetic resin, and the surface thereof has a white color that exhibits excellent reflectivity. The reflection sheet 21 is arranged on the inner surface side of the LED board 18 (on the mounting surface side of the LEDs 17) so as to cover substantially the entire area thereof. The reflection sheet 21 has lens insertion holes 21a through which each diffuser lens 19 is inserted at positions overlapping with the diffuser lenses 19 (LEDs 17) in plan view. This reflection sheet 21 enables reflection of the light within the chassis 14 toward the side of the optical members 15.

Subsequently, the cooling fans 22 arranged on the back surface side of the chassis 14 (on the side opposite to the side of the LEDs 17) will be described in detail. As shown in FIG. 4, each of the cooling fans 22 includes a fan body 22a attached to the surface on the back side of the bottom plate 14a of the chassis 14, and a fan 22b pivotally supported so as to be rotatable within the fan body 22a. The fan body 22a is configured to allow the internal and external air to freely flow therethrough, and to allow the external air to be blown toward the bottom plate 14a of the chassis 14 in association with the rotation of each fan 22b. This enables the bottom plate 14a of the chassis 14 and the LED board 18 to be cooled, and the LEDs 17 to be cooled through the bottom plate 14a and the LED board 18.

As shown in FIGS. 5 and 6, a number of cooling fans 22 are arranged in a matrix in the row direction corresponding to the X-axis direction and in the column direction corresponding to the Y-axis direction on the bottom plate 14a of the chassis 14. The cooling fans 22 are arranged at positions correlated with the locations of the diffuser lenses 19 (LEDs 17) within the chassis 14, and are arranged at a substantially middle position of the diffuser lenses 19 (LEDs 17) adjacent to each other in the X-axis direction and in the Y-axis direction. Specifically, the cooling fans 22 are arranged in each area between the diffuser lenses 19 (LEDs 17) adjacent to each other in the Y-axis direction. And the cooling fans 22 are intermittently arranged in every other area between the diffuser lenses 19 (LEDs 17) adjacent to each other in the X-axis direction. Each one of the cooling fans 22 is arranged to correspond to four LEDs 17 including two adjacent LEDs 17 arranged in the X-axis direction and two adjacent LEDs 17 arranged in the Y-axis direction. Each of the cooling fans 22 is arranged such that the central position of the cooling fan 22 is located to have substantially a same distance from each of the corresponding four LEDs 17. The four LEDs 17 corresponding to the cooling fan 22 constitute one LED group 23. Accordingly, among the LEDs 17, the LEDs 17 positioned at both ends in the Y-axis direction are included in only one LED group 23, and are not redundantly included in a plurality of LED groups 23. Meanwhile, the LEDs 17 located at positions other than the both end positions in Y-axis direction (on the center side excluding the both ends) are redundantly included in two LED groups 23.

The cooling fans 22 described above are connected in parallel with the LEDs 17 correlated with the locations thereof in the chassis 14. Specifically, as shown in FIG. 9, the cooling fans 22 and the correlated LEDs 17 are connected in parallel with each other to the LED control portion 33. Accordingly, when the LED control portion 33 drives the LEDs 17, the cooling fans 22 are also driven in conjunction with the driven LEDs 17. That is, the LED control portion 33 is configured to control driving of the cooling fans 22 in conjunction with driving of the LEDs 17. Thus, it can be said that the LED control portion 33 also serves as a fan control portion (cooling control portion). Note that in FIG. 9, only one cooling fan 22 is illustrated for convenience.

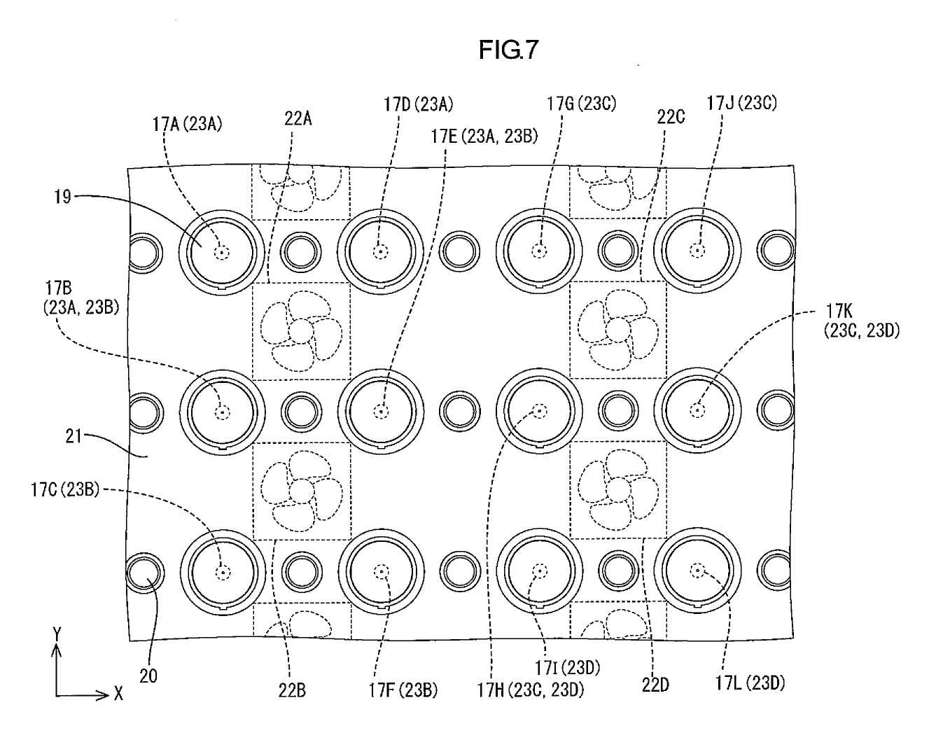

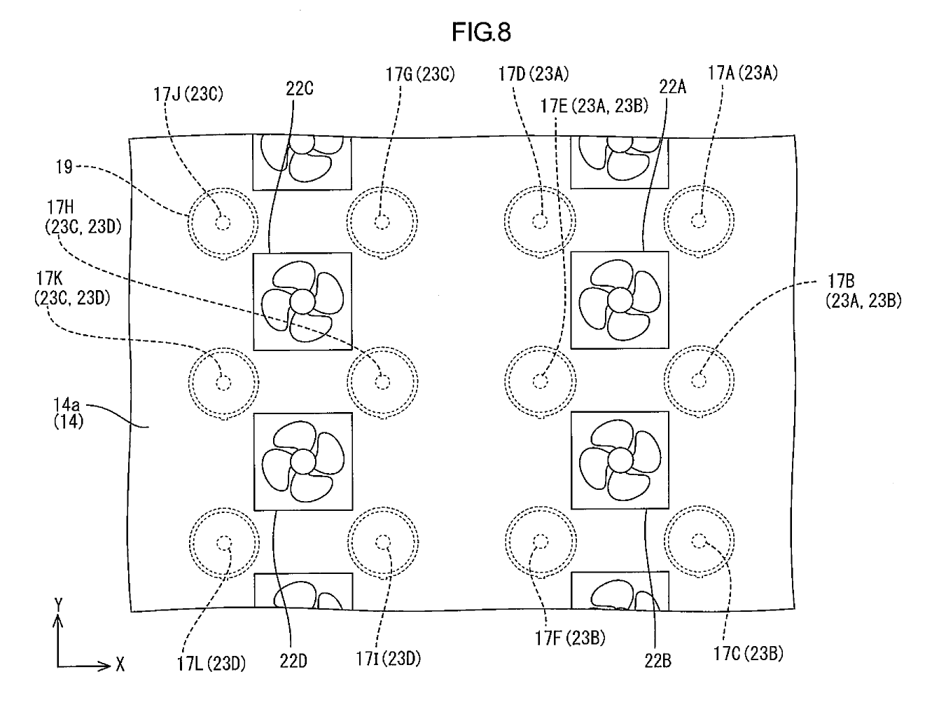

The specific relationship between the LEDs 17 and the cooling fans 22 correlated with the LEDs 17 will be described. For ease of explanation, assume the configuration where, as shown in FIGS. 7 and 8, four LEDs 17 are arranged in each row in the X-axis direction and three LEDs 17 are arranged in each column in the Y-axis direction, that is twelve LEDs 17 in total are arranged among the LEDs 17 arranged in a dispersed manner in the chassis 14, and four cooling fans 22 are correlated with these LEDs 17. The twelve LEDs 17 include: three LEDs 17 constituting the left-end row shown in FIG. 7, that is, a first LED 17A, a second LED 17B, and a third LED 17C, which are arranged in this order from the top of the figure; three LEDs 17 constituting the right-side column in the figure, that is, a fourth LED 17D, a fifth LED 17E, and a sixth LED 17F, which are arranged in this order from the top of the figure; three LEDs 17 constituting the right-side column in the figure, that is, a seventh LED 17G, an eighth LED 17H, and a ninth LED 17I, which are arranged in this order from the top of the figure; and three LEDs 17 constituting the right-side column in the figure, that is a tenth LED 17J, an eleventh LED 17K, and a twelfth LED 17L, which are arranged in this order from the top in the figure. Hereinafter, indices A to L are added to reference numerals to distinguish the LEDs 17, and no index is added to reference numerals when the LEDs 17 are collectively denoted without distinguishing the LEDs. In FIG. 8, the left side and the right side are reversed from those in FIG. 7.

The twelve LEDs 17 described above constitute four LED groups 23 (a first LED group 23A to a fourth LED group 23D). Each LED group 23 includes four LEDs 17 that are arranged in adjacent to each other in the X-axis direction and in the Y-axis direction. Specifically, the four LEDs 17 (the first LED 17A, the second LED 17B, the fourth LED 17D, and the fifth LED 17E) shown in the upper left of FIG. 7 constitute the first LED group 23A; the four LEDs 17 (the second LED 17B, the third LED 17C, the fifth LED 17E, and the sixth LED 17F) in the lower left in the figure constitute the second LED group 23B; the four LEDs 17 (the seventh LED 17G, the eighth LED 17H, the tenth LED 17J, and the eleventh LED 17K) shown in the upper right of the figure constitute the third LED group 23C; and the four LEDs 17 (the eighth LED 17H, the ninth LED 17I, the eleventh LED 17K, and the twelfth LED 17L) shown in the lower right of the figure constitute the fourth LED group 23D. Hereinafter, indices A to D are added to reference numerals to distinguish the LED groups 23, and no index is added to reference numerals when the LED groups 23 are collectively denoted without distinguishing the LED groups.

The second LED 17B and the fifth LED 17E are redundantly included in both the first LED group 23A and the second LED group 23B, while the first LED 17A, the third LED 17C, the fourth LED 17D, and the sixth LED 17F are included in only one of the first LED group 17A and the second LED group 17B. Similarly, the eighth LED 17H and the eleventh LED 17K are redundantly included in both the third LED group 23C and the fourth LED group 23D, while the seventh LED 17G, the ninth LED 17I, the tenth LED 17J, and the twelfth LED 17L are included in only one of the third LED group 17C and the fourth LED group 17D.

As shown in FIG. 7, each of the cooling fans 22 positioned at substantially the center of each LED group 23 in plan view is correlated with the LED group 23, and the four LEDs 17 constituting the LED group 23 are connected in parallel with the corresponding cooling fan 22. Specifically, a first cooling fan 22A is positioned at substantially the center of the first LED group 23A. A second cooling fan 22B is positioned at substantially the center of the second LED group 23B. A third cooling fan 22C is positioned at substantially the center of the third LED group 23C. A fourth cooling fan 22D is positioned at substantially the center of the fourth LED group 23D. Hereinafter, indices A to D are added to reference numerals to distinguish the cooling fans 22, and no index is added to reference numerals when the cooling fans 22 are collectively denoted without distinguishing the cooling fans.

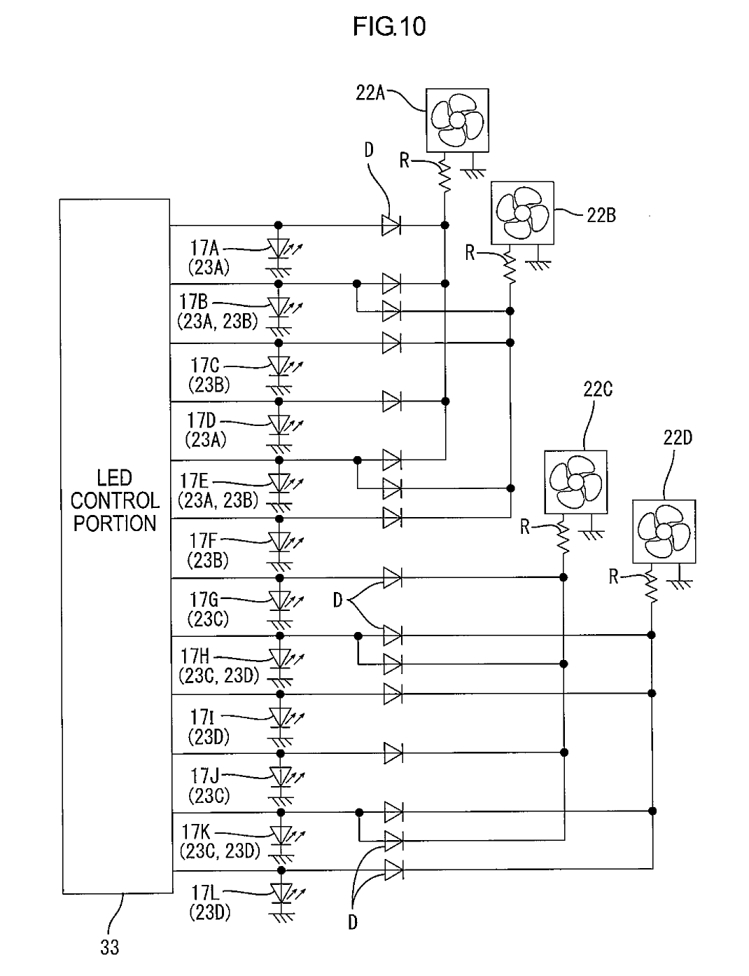

The four LEDs 17 (the first LED 17A, the second LED 17B, the fourth LED 17D, and the fifth LED 17E) constituting the first LED group 23A are connected to the first cooling fan 22A as shown in FIG. 10, and one of the four LEDs 17 constituting the first LED group 23A is driven to thereby allow the first cooling fan 22A to be driven in conjunction with the driven LED 17. Similarly, the four LEDs 17 (the second LED 17B, the third LED 17C, the fifth LED 17E, and the sixth LED 17F) constituting the second LED group 23B are connected to the second cooling fan 22B, and one of the four LEDs 17 constituting the second LED group 23B is driven to thereby allow the second cooling fan 22B to be driven in conjunction with the driven LED. Like the first cooling fan 22A and the second cooling fan 22B, the third cooling fan 22C and the fourth cooling fan 22D are respectively connected to the correlated LEDs 17 of the third LED group 23C and the fourth LED group 23D, and are driven in conjunction with the driven LEDs 17. Note that diodes D and resistors R are interposed as rectifiers between each cooling fan 22 and the LED control portion 33.

Note that in FIGS. 7, 8, and 10, the example in which 12 LEDs 17 and four corresponding cooling fans 22 are arranged is illustrated. However, the circuit configuration and the like can be appropriately changed according to the number and the arrangement of the LEDs 17 and cooling fans 22 to be actually installed in the liquid crystal display device 10 with reference to the drawings, as a matter of course.

This embodiment has a configuration as described above, and the operation thereof will be subsequently described. As shown in FIG. 9, when image signal such as television broadcasting signal is input to the image signal processing portion 31 via the antenna 30 and the tuner T, the signal is subjected to image processing and the signal is output to each of the liquid crystal panel control portion 32 and the LED control portion 33. Then, the liquid crystal panel control portion 32 controls driving of the liquid crystal panel 11, and the LED control portion 33 controls driving of the LEDs 17. The backlight unit 12 applies illumination light to the liquid crystal panel 11, thereby displaying a predetermined image on the liquid crystal panel 11.

In the LED control portion 33, driving of each LED 17 is individually controlled based on the signal received from the image signal processing portion 31. For example, when an image to be displayed on the liquid crystal panel 11 includes a black display area and a non-black display area, the LEDs 17 arranged to supply light mainly to the non-black display area (specifically, an arrangement overlapping with the non-black display area in plan view, for example) are lit, and the LEDs 17 arranged to supply light mainly to the black display area (specifically, an arrangement overlapping with the black display area in plan view, for example) are unlit. Thus, lighting on and off of each LED 17 is controlled to synchronize with a display image, thereby ensuring a large difference in brightness between the black display area and the non-black display area and obtaining a high contrast performance. Additionally, an excellent display quality and reduction in power consumption can be achieved. In particular, depending on the type of the image signal to be input to the liquid crystal display device 10, the upper and lower ends or the right and left ends of the display screen may always be defined as the black display area. In this configuration, it is preferable to perform control such that the LEDs 17 corresponding to the black display area at the end of the screen are always unlit and the LEDs 17 corresponding to the non-black display area on the central side of the screen are always lit.

The LED control portion 33 is configured to also control driving of each cooling fan 22 in conjunction with the control for driving each LED 17 as described above. That is, the LEDs 17 and the cooling fans 22 correlated with the LEDs 17 are connected to the LED control portion 33 in parallel with each other. If the predetermined LEDs 17 are driven to be lit, the cooling fans 22 correlated with the LEDs 17 can also be driven in conjunction with the driven LEDs. This enables the LEDs 17 that generates heat upon lighting to be effectively cooled by the cooling fans 22 correlated in conjunction with the LEDs (FIG. 4).

Specifically, as shown in FIGS. 7 and 8, a single cooling fan 22 positioned at substantially the center in plan view is correlated with the LED group 23 constituted by the four LEDs 17 including two LEDs 17 arranged in the X-axis direction and two LEDs 17 arranged in the Y-axis direction. Further, as shown in FIG. 10, the four LEDs 17 constituting one LED group 23 are each connected to the cooling fan 22. Accordingly, when the LED control portion 33 allows at least one of the four LEDs 17 constituting one LED group 23 to be lit, the cooling fan 22 connected to these LEDs 17 are driven, thereby achieving cooling. Specifically, when at least one of the four LEDs 17 (the first LED 17A, the second LED 17B, the fourth LED 17D, and the fifth LED 17E) constituting the first LED group 23A is lit, driving power is supplied to the first cooling fan 22, thereby cooling the LEDs 17 constituting the first LED group 23A. In particular, since the second LED 17B and the fifth LED 17E are included in both the first LED group 23A and the second LED group 23B, when at least one of the LEDs 17B and 17E is lit, both the first cooling fan 22A and the second cooling fan 22B are driven, thereby obtaining a twofold blasting ability. Accordingly, these LEDs 17B and 17E can be rapidly cooled.

On the other hand, when each of the four LEDs 17 constituting one LED group 23 is unlit, the cooling fan 22 connected to the LEDs 17 is not driven. When each of the LEDs 17 constituting the LED group 23 is unlit, these LEDs 17 generate no heat and the temperature does not rise, which substantially eliminates the need for cooling by the cooling fan 22. Specifically, when at least one of the LEDs 17 constituting the first LED group 23A is lit, the first cooling fan 22A is driven. On the contrary, when each of the LEDs 17 (the eighth LED 17H, the ninth LED 17I, the eleventh LED 17K, the twelfth LED 17L) is unlit, no driving power is supplied to the fourth cooling fan 22D. Thus the fourth cooling fan 22D is not driven. Therefore, the power consumption involved in driving the cooling fans 22 can be reduced by selectively driving the LEDs 17 depending on the lighting on and off the LEDs 17 correlated with the cooling fans 22. Furthermore, a number of cooling fans 22 are arranged in a dispersed manner at positions correlated with the LED group 23, thereby evenly cooling each LED group 23 effectively.

As described above, the backlight unit 12 of this embodiment includes the LEDs 17 serving as a plurality of light sources; the chassis 14 housing the LEDs 17; the cooling fans 22 serving as a plurality of cooling portions arranged at positions correlated with locations of the LEDs 17 in the chassis 14; the light source control portion controlling driving of each LED 17; and the LED control portion 33 serving as a cooling control portion controlling driving of each cooling fan 22 correlated based on driving of the LEDs 17.

This configuration enables the LED control portion 33 serving as a light source control portion to control driving of the plurality of LEDs 17, and enables the LED control portion 33 serving as a cooling control portion to control driving of each corresponding cooling fan 22 based on driving of the LEDs 17. At this time, it is possible to perform control such that each cooling fan 22 correlated with lit LEDs 17 is driven and each cooling fan 22 correlated with unlit LEDs 17 is not driven. Thus, the plurality of cooling fans 22 is arranged at positions correlated with the locations of the LEDs 17 and the cooling fans 22 are selectively driven, thereby making it possible to selectively cool the LEDs 17 in which heat is generated upon lighting. Accordingly, in comparison with the configuration in which the entire backlight unit 12 is cooled, the power consumption involved in driving the cooling fans 22 can be reduced and the LEDs 17 to be cooled can effectively be cooled. Furthermore, uneven cooling hardly occurs and the cooling fans 22 can remain small. Consequently, reduction in power consumption is achieved and sufficient heat dissipation performance can be obtained.

The LEDs 17 and the cooling fan 22 correlated with the LEDs 17 are connected in parallel with each other to the LED control portion 33, and the LED control portion 33 also serves as the cooling control portion described above to control driving of the LEDs 17 and driving of the cooling fans 22 in relation to each other. This configuration enables simplification of the circuit configuration for controlling the LEDs 17 and the cooling fans 22 and achieves cost reduction, in comparison with the configuration where the LED control portion connected to the LEDs 17 is provided independently of the cooling control portion connected to the cooling fans 22.

Each of the cooling fans 22 is correlated and connected with the plurality of LEDs 17. With this configuration, when at least one of the plurality of LEDs 17 correlated with the cooling fan 22 is lit, the cooling fan 22 is driven in conjunction with the lit LED, the lit LED 17 can be cooled. In comparison with the configuration where each of the cooling fans is respectively correlated with each of the LEDs 17, the number of the cooling fans 22 to be installed can be reduced.

The plurality of LEDs 17 connected to the cooling fan 22 is arranged at positions adjacent to each other in the chassis 14. With this configuration, the lit LEDs 17 among the plurality of LEDs 17 arranged to be adjacent to each other in the chassis 14 can be effectively cooled by driving the cooling fans 22.

The cooling fan 22 is arranged on the chassis at a substantially middle position of the plurality of LEDs 17 connected to the cooling fan 22. With this configuration, when the cooling fan 22 is driven, the LEDs 17 connected to the driven cooling fan 22 can be cooled substantially evenly.

The plurality of LEDs 17 connected to the corresponding cooling fan 22 constitutes one LED group 23 serving as a light source group. Some of the LEDs 17 are redundantly included in a plurality of LED groups 23. With this configuration, the LEDs 17 included in the plurality of LED groups 23 can be cooled by the plurality of cooling fans 22, thereby allowing the LEDs 17 to be rapidly cooled. In particular, this configuration is suitable when high-power LEDs 17 are used or when LEDs 17 are arranged at positions where heat accumulation is likely to occur, for example.

The plurality of LEDs 17 connected to the corresponding cooling fan 22 constitutes one LED group 23. Some of the LEDs 17 are included in one LED group 23 and not redundantly included in a plurality of LED groups 23. With this configuration, the number of the cooling fans 22 to be installed can be reduced, in comparison with the configuration where the LEDs 17 are redundantly included in the plurality of LED groups 23.

The cooling fans 22 are arranged on the side of the chassis 14 opposite to the side on which the LEDs 17 are arranged. With this configuration, when the cooling fans 22 are driven, neighboring portions of the cooling fans 22 in the chassis 14 are cooled, thereby indirectly cooling the LEDs 17 through the neighboring portions of the cooling fans 22 in the chassis 14. The LEDs 17 and the cooling fans 22 are not provided on the same side of the chassis 14, which facilitates installation of the LEDs 17 and the cooling fans 22.

Each of the cooling portions may be the cooling fan 22. With this configuration, the LEDs 17 can be effectively cooled by the cooling fan 22.

Each of the light sources may be the LED 17. Since each LED 17 is a light source whose brightness and product lifetime are liable to deteriorate under high-temperature environments, this configuration enables a high brightness to be maintained and achieves a long product lifetime by effectively cooling the LEDs 17 by the cooling fans 22.

The liquid crystal display device 10 according to this embodiment includes the backlight unit 12 and the liquid crystal panel 11 displaying an image using light from the backlight unit 12. According to the liquid crystal display device 10 having such a configuration, reduction in power consumption can be achieved and sufficient heat dissipation performance can be obtained in the backlight unit 12 supplying light to the liquid crystal panel. Consequently, reduction in power consumption and a display with a high display quality can be realized.

The liquid crystal display device 10 described above includes the image signal processing portion 31 processing signal associated with an image, and the liquid crystal panel control portion 32 controlling driving of the liquid crystal panel 11 based on the output signal from the image signal processing portion 31. The LED control portion 33 (including the cooling control portion) is configured to control driving of each of the LEDs 17 and the cooling fans 22 based on the output signal from the image signal processing portion 31. With this configuration, the LED control portion 33 controls driving of the LEDs 17 based on the output signal from the image signal processing portion 31, thereby enabling control such that the LEDs 17 corresponding to the portions other than the black display portion of the image to be displayed are lit and the LEDs 17 corresponding to the black display portion are unlit, for example. This leads to an improvement in contrast characteristic of the display image. In addition, when the LED control portion 33 controls driving of the cooling fans 22 based on the output signal from the image signal processing portion 31, the cooling fans 22 correlated with the lit LEDs 17 are driven and the cooling fans 22 correlated with the unlit LEDs are not driven, thereby achieving reduction in power consumption and effectively cooling the LEDs 17 to be cooled.

### Other Embodiment

The present invention is not limited to the above embodiments in the above description and drawings. The following embodiments may be included in the technical scope of the present invention, for example.

(1) The above-described embodiment illustrates the configuration in which driving of the cooling fans is controlled in conjunction with lighting on and off of the LEDs. Alternatively, it is possible to control brightness of each LED as well as to control such that the cooling fans are driven when the brightness is equal to or higher than a threshold of the brightness (current value), while the cooling fans are not driven when the brightness is equal to or lower than the threshold, for example.

(2) The above-described embodiment illustrates the configuration in which the LEDs and the cooling fans are driven in conjunction with each other by the LED driving portion. Alternatively, the LED control portion (light source control portion) driving only the LEDs may be provided independently of the fan control portion (cooling control portion) driving only the cooling fans, and the both control portions may be synchronized to selectively drive the cooling fans according to the driving of the LEDs. As a specific method of synchronizing the LED control portion and the fan control portion described above, it is possible to employ a method of supplying output signal from the image signal processing portion to each of the LED control portion and the fan control portion. In addition, a illuminance sensor configured to detect lit LEDs, or a thermal sensor configured to detect LEDs in which heat is generated upon lighting, for example, may be connected to the fan control portion, and the cooling fans correlated with the detected LEDs may be selectively driven.

(3) The above-described embodiment illustrates the configuration where there are LEDs redundantly included in two LED groups and LEDs included in only one LED group. Alternatively, all LEDs may be set to be redundantly included in two LED groups, or all LEDs may be set to be included in only one LED group instead of being redundantly included in a plurality of LED groups.

(4) The above-described embodiment illustrates the configuration in which the cooling fans are intermittently arranged in each region between LEDs in the X-axis direction, and the LEDs located at positions other than the both ends in the Y-axis direction are redundantly included in two LED groups. Alternatively, the cooling fans may be arranged in each region between the LEDs in the X-axis direction, and the LEDs may be redundantly included in four or two LED groups.

(5) The above-described embodiment illustrates the configuration in which the corresponding cooling fan is driven when at least one of the four LEDs constituting each LED group is lit. Alternatively, the cooling fans may not be driven unless two or more LEDs are lit.

(6) Though the above-described embodiment illustrates the configuration in which the cooling fans are individually driven, the present invention also includes a configuration in which a plurality of cooling fans is driven at one time.

(7) Though the above-described embodiment illustrates the configuration in which the cooling fans are arranged at the central position of the LED group, the present invention includes a configuration in which the cooling fans are eccentrically located from the central position of the LED group. The present invention also includes a configuration in which the cooling fans are arranged to overlap with the LEDs in plan view.

(8) Though the above-described embodiment illustrates the configuration in which one LED group includes four LEDs, the present invention also includes a configuration in which three or less LEDs constitute one LED group or five or more LEDs constitute one LED group. In this configuration, the cooling fans may be arranged to be correlated with the locations of the LEDs included in the LED group.

(9) Though the above-described embodiment illustrates the configuration in which the cooling fans are arranged at positions correlated with the LED group including a plurality of LEDs, the present invention also includes a configuration in which the cooling fans are respectively correlated with the LEDs. In this configuration, the cooling fans may be preferably arranged to overlap with the LEDs in plan view.

(10) In addition to the above-described embodiment, the present invention also includes a configuration in which the LED board is divided into a plurality of portions.

(11) Though the above-described embodiment illustrates the configuration in which the cooling fans are arranged outside the chassis, the present invention also includes a configuration in which the cooling fans are arranged within the chassis.

(12) The above-described embodiment illustrates the configuration using the cooling fans as the cooling portions. Alternatively, a cooling fan and a heat sink may be used in combination, and the cooling fan and the heat sink may constitute the cooling portions.

(13) Though the above-described embodiment illustrates the configuration of using the cooling fans as the cooling portions, the present invention also includes a configuration in which a Peltier element and the like are used as the cooling portions, in addition to the cooling fans.

(14) Though the above-described embodiment illustrates the configuration where the LEDs are used as the light sources, other types of light sources, such as an organic EL, may also be used.

(15) Though above-described embodiment illustrates the configuration in which the liquid crystal panel is arranged in a longitudinally placed state assuming that the short-side direction thereof aligned with the vertical direction, the present invention also includes a configuration in which the liquid crystal panel is arranged in a longitudinally placed state assuming that the long-side direction thereof aligned with the vertical direction.

(16) The above-described embodiment illustrates the liquid crystal display device used for a television receiver. In addition to this, it is particularly preferable to apply the present invention to an application in which a display image of a display for advertisement, for example, is not changed for a predetermined period of time.

(17) In the above-described embodiment, the TFTs are used as the switching components of the liquid crystal display device. However, the present invention is also applicable to a liquid crystal display device using switching components other than TFTs (for example, a thin-film diode (TFD)), and is also applicable to a liquid crystal display device performing monochrome display, in addition to the liquid crystal display device performing color display.

(18) Though the above-described embodiment illustrates the liquid crystal display device using a liquid crystal panel as a display panel, the present invention is also applicable to a display device using other types of display panel.

(19) Though the above-described embodiment illustrates the television receiver including a tuner, the present invention is also applicable to a display device including no tuner.

1. A lighting device comprising:
a plurality of light sources;
a chassis housing the light sources;
a plurality of cooling portions arranged on the chassis corresponding to locations of the light sources;
a light source control portion configured to control driving of the light sources; and
a cooling control portion configured to control driving of one of the cooling portions based on driving of a corresponding light source.

2. The lighting device according to claim 1, wherein:
one of the light sources and a corresponding cooling portion are connected in parallel to the light source control portion; and
the light source control portion serves as the cooling control portion and configured to control driving of the cooling portion and driving of the light source in relation to each other.
claim: The lighting device according to claim 2, wherein the cooling portion corresponds to the plurality of light sources and is connected to the plurality of light sources.

4. The lighting device according to claim 3, wherein the plurality of light sources connected to the cooling portion is arranged at positions adjacent to each other in the chassis.

5. The lighting device according to claim 3, wherein the cooling portion is arranged on the chassis at a substantially middle position of the plurality of light sources connected to the cooling portion.

6. The lighting device according to claim 3, wherein:
the plurality of light sources that are connected to the corresponding cooling portion form one light source group; and
at least one of the light sources of the one light source group is redundantly included in another light source group.

7. The lighting device according to claim 3, wherein:
the plurality of light sources that are connected to the corresponding cooling portion form one light source group; and
at least one of the light sources of the one light source group is included in the one light source group and is not redundantly included in another light source group.

8. The lighting device according to claim 1, wherein the cooling portions are arranged on a side of the chassis opposite to a side on which the light sources are arranged.

9. The lighting device according to claim 1, wherein each of the cooling portions is a cooling fan.

10. The lighting device according to claim 1, wherein each of the light sources is an LED.

11. A display device comprising:
the lighting device according to claim 1; and
a display panel displaying an image using light from the lighting device.

12. The display device according to claim 11, further comprising:
an image signal processing portion processing signal associated with the image; and
a display panel control portion controlling driving of the display panel based on output signal from the image signal processing portion,
wherein the light source control portion and the cooling control portion respectively control driving of the light source and driving of the cooling portions based on the output signal from the image signal processing portion.

13. The display device according to claim 11, wherein the display panel is a liquid crystal panel having a liquid crystal encapsulated in a gap between a pair of substrates.

14. A television receiver comprising a display device according to claim 11.
